(19) United States
(12) Patent Application Publication
(10) Pub. No.: US 2016/0076357 A1
(43) Pub. Date: Mar. 17, 2016

(54) METHODS FOR SELECTING AND OPTIMIZING DRILLING SYSTEMS

(71) Applicant: SCHLUMBERGER TECHNOLOGY CORPORATION, HOUSTON, TX (US)

(72) Inventor: SLIM HBAIEB, RIO DE JANEIRO (BR)

(21) Appl. No.: 14/483,924

(22) Filed: Sep. 11, 2014

(51) Int. Cl. E21B 47/00; G01V 1/40; E21B 45/00

(52) U.S. Cl. CPC E21B 47/00; E21B 45/00; G01V 1/40

(57) ABSTRACT

A method for selecting a drill bit, the method includes obtaining a plurality of data of a first well within an earth formation, correlating the plurality of data of the first well to identify a set of reduced variables of the plurality of data, segmenting the reduced set of the plurality of data into a plurality of facies based on one of drillability and steerability, performing analysis of drilling performance of each of the plurality of facies, and selecting a drill bit based on the drilling performance.

### BACKGROUND

Operations, such as geophysical surveying, drilling, logging, well completion, hydraulic fracturing, steam injection, and production, are typically performed to locate and gather valuable subterranean assets, such as valuable fluids or minerals. The subterranean assets are not limited to hydrocarbons such as oil or gas. Throughout this document, the terms “oilfield” and “oilfield operation” may be used interchangeably with the terms “field” and “field operation” to refer to a site where any types of valuable fluids or minerals can be found and the activities required to extract them. Further, the term “field operation” refers to a field operation associated with a field, including activities related to field planning, wellbore drilling, wellbore completion, production using the wellbore (also referred to as borehole), and abandonment of a well after production has completed (well sealing).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments of the present disclosure relate to a method for selecting a drill bit, the method includes obtaining a plurality of data of a first well within an earth formation, correlating the plurality of data of the first well to identify a set of reduced variables of the plurality of data, segmenting the reduced set of the plurality of data into a plurality of facies based on one of drillability and steerability, performing analysis of drilling performance of each of the plurality of facies, and selecting a drill bit based on the drilling performance.

In general, in another aspect, one or more embodiments of the present disclosure relate to a method for real time optimization of an operating parameter during drilling, the method includes measuring and obtaining a plurality of data of an earth formation in real time, segmenting the earth formation into a plurality of facies by identifying one or more variables of the plurality of data using a cluster analysis technique, and predicting a formation change based on the measured plurality of data.

In general, in yet another aspect, one or more embodiments of the present disclosure relate to a method of optimizing drilling parameters, the method includes obtaining previously acquired data of a well of the formation, obtaining current data of the well of the formation, estimating the property of the formation by comparing the current data to the previously acquired data, and changing at least one of a drilling system parameter and a drilling operating parameter based on the estimated property.

Other aspects and advantages of the invention will be apparent from the following description and the appended claims.

### BRIEF DESCRIPTION OF DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 shows a conventional drilling system for drilling an earth formation.

FIG. 2 shows a conventional fixed-cutter bit.

FIG. 3 shows a data plot in accordance with one or more embodiments of the present disclosure.

FIG. 4 shows a method in accordance with one or more embodiments of the present disclosure.

FIG. 5 shows multiple wells in accordance with one or more embodiments of the present disclosure.

FIG. 6 shows a method in accordance with one or more embodiments of the present disclosure.

FIG. 7 shows a computer system in accordance with one or more embodiments of the present disclosure.

### DETAILED DESCRIPTION

Embodiments are shown in the above-identified drawings and described below. In describing the embodiments, like or identical reference numerals are used to identify common or similar elements. The drawings are not necessarily to scale and certain features may be shown exaggerated in scale or in schematic in the interest of clarity and conciseness.

While most of the terms used herein will be recognizable to those of skill in the art, it should be understood, however, that when not explicitly defined, terms should be interpreted as adopting a meaning presently accepted by those skilled in the art.

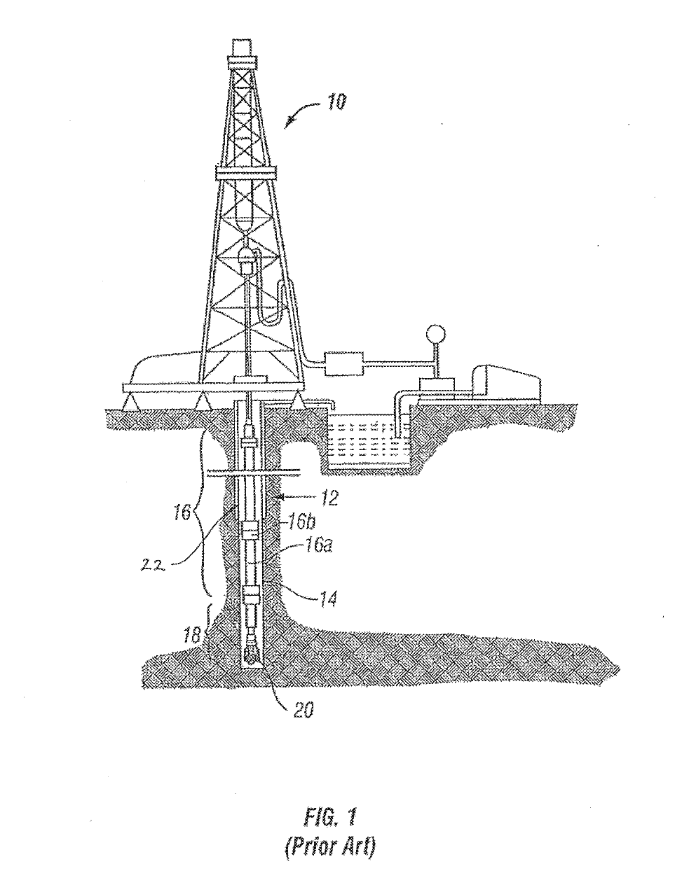

FIG. 1 shows one example of a conventional drilling system for drilling an earth formation. The drilling system includes a drilling rig 10 used to turn a drilling tool assembly 12 that extends downward into a wellbore 14. The drilling tool assembly 12 includes a drill string 16, and a bottomhole assembly (BHA) 18, which is attached to the distal end of the drill string 16. The “distal end” of the drill string is the end furthest from the drilling rig.

The drill string 16 includes several joints of drill pipe 16a connected end to end through tool joints 16b. The drill string 16 is used to transmit drilling fluid (through its hollow core) and to transmit rotational power from the drill rig 10 to the BHA 18. In some cases the drill string 16 further includes additional components such as subs, pup joints, etc.

The BHA 18 includes at least a bit 20. BHAs may also include additional components attached between the drill string 16 and the bit 20. Examples of additional BHA components include drill collars, stabilizers (“stabs”), measurement-while-drilling (MWD) tools, logging-while-drilling (LWD) tools, subs, hole enlargement devices (e.g., hole openers and reamers), jars, accelerators, thrusters, downhole motors, and rotary steerable systems.

When drilling, sufficient rotational moment and axial force must be applied to the bit 20 to cause the cutting elements of the bit 20 to cut into material and/or crush formation as the bit 20 is rotated. The axial force applied on the bit 20 is referred to as the “weight on bit” (WOB). The rotational moment applied to the drilling tool assembly 12 at the drill rig 10 (usually by a rotary table or a top drive mechanism) to turn the drilling tool assembly 12 is referred to as the “rotary torque.” Additionally, the speed at which the rotary table rotates the drilling tool assembly 12, measured in revolutions per minute (RPM), is referred to as the “rotary speed.”

While drilling, it is desirable to gather as much data about the drilling process and about the formations through which the borehole 14 penetrates. The following description provides examples of the types of sensors that are used and the data that are collected. It is noted that in practice, it is impractical to use all of the sensors described below due to space and time constraints. In addition, the following description is not exhaustive. Other types of sensors are known in the art that may be used in connection a drilling process, and the invention is not limited to the examples provided herein.

The first type of data that are collected may be classified as near instantaneous measurements, often called “rig sensed data” because it is sensed on the rig. These include the WOB and the TOB, as measured at the surface. Other rig sensed data include the RPM, the casing pressure, the depth of the drill bit, and the drill bit type. In addition, measurements of the drilling fluid (“mud”) are also taken at the surface. For example, the initial mud condition, the mud flow rate, and the pumping pressure, among others. All of these data may be collected on the rig 101 at the surface, and they represent the drilling conditions at the time the data are available.

Other measurements are taken while drilling by instruments and sensors in the BHA 106. These measurements and the resulting data are typically provided by an oilfield services vendor that specializes in making downhole measurements while drilling. The invention, however, is not limited by the party that makes the measurements or provides the data.

As described with reference to FIG. 1, BHA 18 may include a number of downhole tools. Downhole tools may include various sensors for measuring the properties related to the formation and its contents, as well as properties related to the borehole conditions and the drill bit. In general, “logging-while-drilling” (“LWD”) refers to measurements related to the formation and its contents. “Measurement-while-drilling” (“MWD”), on the other hand, refers to measurements related to the borehole and the drill bit.

LWD sensors located in a BHA 18 may include, for example, one or more of a gamma ray tool, a resistivity tool, an NMR tool, a sonic tool, a formation sampling tool, a neutron tool, and electrical tools. Such tools are used to measure properties of the formation and its contents, such as, the formation porosity, density, lithology, dielectric constant, formation layer interfaces, as well as the type, pressure, and permeability of the fluid in the formation.

One or more MWD sensors may also be located in a BHA 18. MWD sensors may measure the loads acting on the drill string, such a WOB, TOB, and bending moments. It is also desirable to measure the axial, lateral, and torsional vibrations in the drill string. Other MWD sensors may measure the azimuth and inclination of the drill bit, the temperature and pressure of the fluids in the borehole, as well as properties of the drill bit such as bearing temperature and grease pressure.

The data collected by LWD/MWD tools is often relayed to the surface before being used. In some cases, the data is simply stored in a memory in the tool and retrieved when the tool it brought back to the surface. In other cases, LWD/MWD data may be transmitted to the surface using known telemetry methods.

Telemetry between the BHA and the surface, such as mud-pulse telemetry, is typically slow and only enables the transmission of selected information. Because of the slow telemetry rate, the data from LWD/MWD may not be available at the surface for several minutes after the data have been collected. In addition, the sensors in a typical BHA 18 are located behind the drill bit, in some cases by as much as fifty feet. Thus, the data received at the surface may be slightly delayed due to the telemetry rate that the position of the sensors in the BHA.

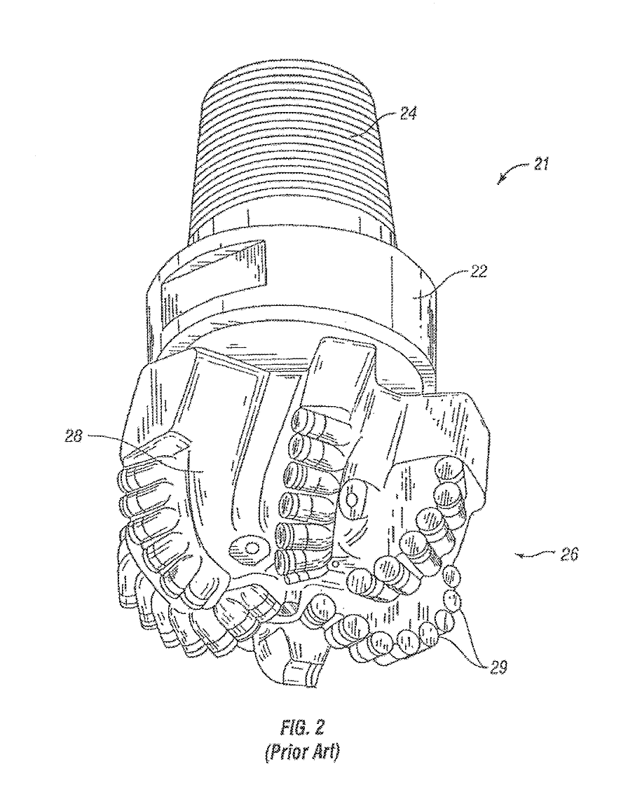

Referring to FIG. 2, an example of a drill bit known as a fixed-cutter bit is shown. Fixed-cutter bit 21 has a bit body 22 having a threaded connection at one end 24 and a cutting head 26 formed at the other end. The head 26 of the fixed-cutter bit 21 includes a plurality of ribs or blades 28 arranged about the rotational axis of the drill bit and extending radially outward from the bit body 22. Cutting elements 29 are embedded in the raised ribs 28 to cut formation as the drill bit is rotated on a bottom surface of a well bore. Cutting elements 29 of fixed-cutter bits include polycrystalline diamond cutters (PDC) or specially manufactured diamond cutters. These drill bits are also referred to as PDC bits or drag bits.

Successful drilling operations require appropriate selection of drilling tools, fluids, and techniques. Drill bits, or similar cutting tools, should be appropriate for the borehole conditions and the materials to be removed. The fluids should be capable of removing drilled material from the wellbore. Additionally, the techniques employed should be appropriate for the anticipated conditions in order to achieve operation objectives.

During drilling, a variety of factors affect the performance and ultimately the success of a drilling operation. For example, the inconsistencies of the earth formation being drilled through as well as the different components and parameters of the drilling system affect factors such as how fast a drill bit is capable of penetrating the earth (rate of penetration, or ROP) and how much degradation of the drill bit (and the drilling system) occurs (e.g., bit grading and/or wear rate). In addition, although the rotations per minute of the drill bit may be controlled in part by the drilling system and the drilling engineers operating the drilling system, the drilling performance (e.g., ROP and/or wear rate) may also depend on the type of formation being drill through and its corresponding properties. Furthermore, during a drilling operation, engineers may determine that a drill bit, when not performing as expected, necessitates replacement or requires maintenance. When this occurs, it may be required that the drill bit be pulled out of hole (POOH).

In order to optimize performance, engineers may consider a variety of factors. For example, when selecting and/or designing a drilling system, engineers may consider a rock profile (e.g., the type of rock and/or the geological, physical, and mechanical characteristics of an earth formation), operating parameters, and/or drill bit parameters, among many others. One of the factors engineers may consider is the heterogeneity (non-uniformity) of the earth formation in which the drilling system is to be drilled or is drilling through. For example, as sedimentary rocks are formed from the layering of deposited material and are often formed in what is or once was a body of water, due to the differences between the layers of deposited rock, drilling through certain sedimentary rocks will not often result in consistent drilling system performance through each layer. As such, the performance of drilling systems when drilling through certain types of formations (e.g., heterogeneous formations) is widely varying and lacks repeatability.

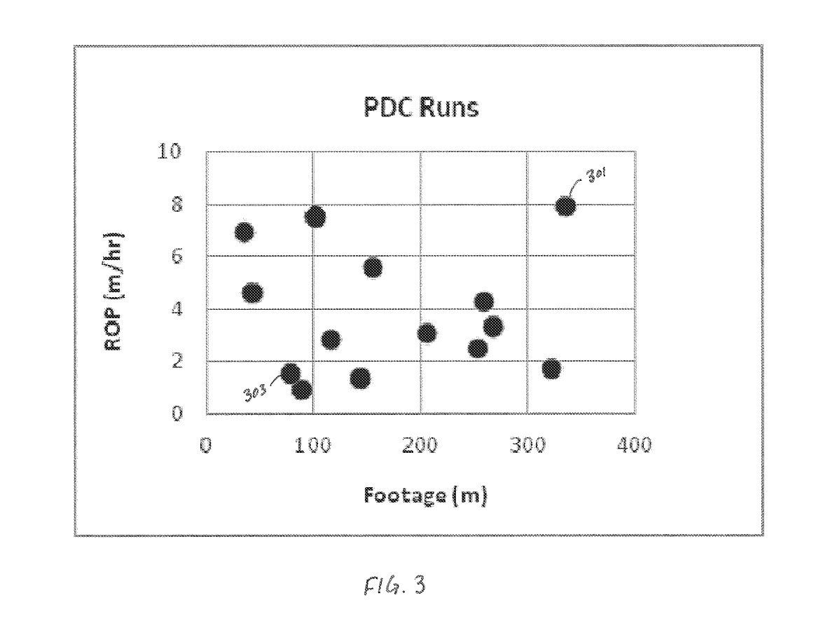

For example, referring to FIG. 3, the rate of penetration (ROP) of a number of PDC runs in a heterogeneous formation are plotted with respect to the distance drilled (footage(m)). As shown in FIG. 3, the ROP for the PDC runs varied from approximately 1 m/hr to 8 m/hr while the distance drilled varied from about 30 m to 330 m. Specifically, in some cases, such as at point 301, the ROP averaged about 8 m/hr and penetrated the formation about 330 m before being POOH. In other cases, at point 303, the ROP averaged under 2 m/hr and penetrated the formation less than 100 m before being POOH. Therefore, as tripping (pulling the drill bit out of the borehole) is often costly, resource intensive, and increases non-production time, underperformance and inconsistent performances may be a significant portion of the challenges marring the success of a drilling operation.

Accordingly, in general, one or more embodiments of the present disclosure provide a method of optimizing performance of different drilling systems by clustering earth formations into segments that exhibit similar characteristics with respect to the difficulty in which a formation can be drilled and, based on the properties of the segment being drilled through and/or the segment about to be drilled through, recommend a set of operating parameters that optimize performance. For sake of clarity, a number of definitions are provided below.

“Drilling system parameters” may include one or more of the following: the type, location, and number of components included in the drilling tool assembly; the length, internal diameter of components, outer diameter of components, weight, and material properties of each component; the type, size, weight, configuration, and material properties of the drilling tool; and the type, size, number, location, orientation, and material properties of the cutting elements on the drilling tool. Material properties in designing a drilling tool assembly may include, for example, the strength, elasticity, and density of the material.

Other drilling system parameters may include properties of one or more bit nozzles, drilling fluid parameters (e.g., viscosity and density of the drilling fluid), bit parameters (e.g., type of bit, size of bit, shape of bit, etc.), and surface components of the drilling system used in operation. It should be understood that drilling tool assembly parameters may include any other configuration or material property of the drilling tool assembly without departing from the scope of the disclosure.

“Operating parameters” may include one or more of the following: the rotary table (or top drive mechanism), speed at which the drilling tool assembly is rotated (RPM), the downhole motor speed (if a downhole motor is included) and the hook load. In other embodiments, drilling operating parameters may include other variables, e.g., rotary torque. One of ordinary skill would appreciate that any operating parameters known in the art may be included without departing from the scope of the present disclosure.

In addition, operating parameters may include one or more “wellbore parameters.” Wellbore parameters may include one or more of the following: the geometry of a well bore and formation material properties (i.e., geologic characteristics). The trajectory of a well bore in which the milling tool assembly is to be confined also is defined along with an initial well bore bottom surface geometry. Because the well bore trajectory may be straight, curved, or a combination of straight and curved sections, well bore trajectories, in general, may be defined by defining parameters for each segment of the trajectory. For example, a well bore may be defined as comprising N segments characterized by the length, diameter, inclination angle, and azimuth direction of each segment and an indication of the order of the segments (i.e., first, second, etc.). Well bore parameters defined in this manner can then be used to mathematically produce a model of the entire well bore trajectory. Formation material properties at various depths along the well bore may also be defined and used. One of ordinary skill in the art will appreciate that well bore parameters may include additional properties, such as friction of the walls of the well bore, casing and cement properties, and well bore fluid properties, among others, without departing from the scope of the disclosure.

The performance of a particular drilling system may be measured by one or more drilling performance parameters. Examples of drilling performance parameters include rate of penetration (ROP), rotary torque required to turn the milling tool assembly, rotary speed at which the drilling tool assembly is turned, drilling tool assembly lateral, axial, or torsional vibrations and accelerations induced during drilling, and weight on bit (WOB). One skilled in the art will appreciate that other performance parameters exist and may be considered without departing from the scope of the disclosure.

In one or more embodiments, in an effort to optimize drilling efficiency, drillability may be defined and used to classify rocks or layers of rock. The drillability of a portion or layer of an earth formation refers to the difficulty in which the layer may be drilled through and may be determined based on a variety of factors. Traditionally, layers of earth formation may be classified based on certain measurable characteristics, such as the type of rock in which it is formed, its mechanical properties, and porosity, among many others. As described herein, however, an earth formation may be segmented into zones that exhibit similar drillability. In addition, zones that exhibit similar drillability may be referred to as a drilling facie (or facie). For example, in one or more embodiments, two zones of a rock formation may be said to have similar drillability if they exhibit similar performances in terms of ROP, vibration signature, and bit grading or wear rate when operating under the same conditions (i.e., when being drilled with similar drilling system parameters and operating parameters). Accordingly, the segmentation of an earth formation into one or more facies is generally based on the performance of a drilling system when drilling using particular operating parameters.

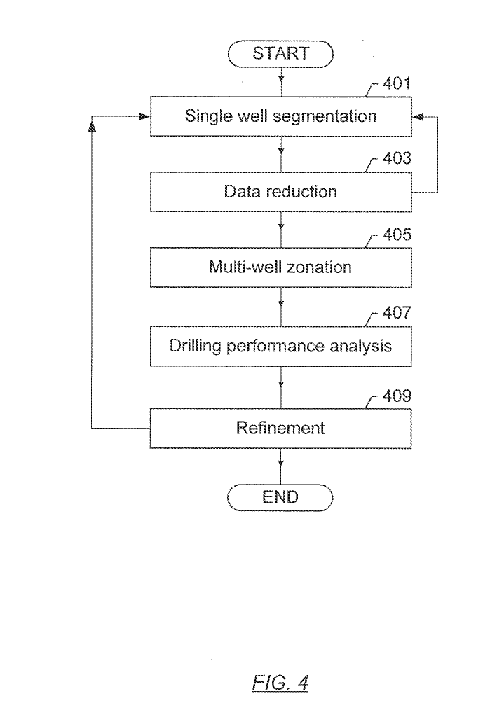

Referring now to FIG. 4, a segmentation workflow in accordance with one or more embodiments is shown. In one or more embodiments, one or more of the elements shown in FIG. 4 may be omitted, repeated, and/or substituted. Accordingly, embodiments of the present disclosure should not be considered limited to the arrangement of elements shown in FIG. 4.

At 401, data from a single well undergoes segmentation. The single well data may include any data, known or acquired, related to the formation surrounding the well. For example, data may include any available physical, mechanical, and/or micro-structural properties of the formation. In addition, the data may include one or more computed variables such as young modulus, compressive strength, and Poisson ratio, among many others. Further, data may be acquired and/or obtained using any technique known in the art, such as seismic, core analysis, and formation evaluation (FE) log data such as shear velocity, density, porosity, gamma ray, etc. Data may be obtained through the use of any tools or techniques known in the art such as MWD and/or LWD tools. Data acquisition, calculations, and analysis may be automated using any system known in the art, such as a computer, for example. Additionally, the acquisition, calculations, and analysis may be done manually, by an engineer for example.

Using the single well data, the well may be segmented into one or more facies that are identified based on physical, mechanical, and/or micro-structural properties. Segmentation may be done by an engineer (e.g., through visual identification) or using one or more numerical analysis techniques (e.g., log clustering). As mentioned above, a facie refers to a layer of formation exhibiting little or no variation in drillability and may contain variety of lithologies.

After data in 401 has been obtained and segmented into one or more facies, the data may be correlated and reduced in 403 using one or more statistical data analysis techniques. One statistical data analysis technique that may be used is known as cluster analysis, which may also be referred to as clustering. Those having ordinary skill would appreciate that any statistical data analysis technique known in the art may be used without departing from the scope of the present disclosure.

Cluster analysis is one of many methodologies used to separate a dataset into groups of data (or clusters). The clusters may be determined based on any number of mathematical and/or physical properties. Clusters may also be determined based on one or more mathematical or physical relationships of the data in the dataset. For example, data belonging to a first group may exhibit similar porosity values (or any other mechanical, physical, geological, or computed variable/characteristic) when compared to each other and data belonging to a second group may also exhibit similar porosity values when compared to each other. However, the porosity values of the first group may be different than the porosity values of the second group.

In addition, cluster analysis may not rely on a single specific algorithm or characteristic during analysis of a given dataset. Rather, clustering often relies on a number of algorithms or a combination of algorithms used to analyze one or more datasets. Further, each algorithm may differ on what particular characteristic(s) are used to determine a particular cluster as well as how to determine which data belongs to a particular cluster.

As clustering may be performed using two or more algorithms, a number of different groupings of a given dataset may be obtained using a plurality of different algorithms. Therefore, the groups of a dataset may be determined using a number of different algorithms where the number of different groupings of the dataset may correspond to the number of algorithms used to analyze the dataset. For example, using one algorithm, data may be grouped based on similar porosity whereas, when using a different algorithm, data may be grouped based on similar compressive strength. As such, the groupings (e.g., the number of clusters and their corresponding data) obtained from the separation of the dataset based on porosity may be different from the groupings obtained from the separation of the dataset based on compressive strength.

Using the clusters determined from cluster analysis, the dataset may be correlated such that two or more characteristics may be compared to each other in order to determine a mathematical, physical, and/or computational relationship between the characteristics, should a relationship exist. As understood by those having ordinary skill in the art, a relationship between two or more variables may include any number of factors, such as the sensitivity of one or more variables with respect to another, the dependence of one or more variables with respect to another, and/or any other mathematical, computational, and/or physical correlation or distribution of one or more variables with respect to another or each other, and indirect relationship between one or more variables with respect to each other, among many other types of relationships and means for determining such relationships. Thus, by having the largest sample of data available for use in cluster analysis, correlation between a number of different variables may be obtained. As such, at least at the outset of the segmentation process, it may be advantageous to obtain data 401 from a well which has the most complete (i.e., the largest amount of data acquired, known, and/or computed) dataset available.

Referring back to 403, in one or more embodiments, as statistical data analysis techniques, e.g., cluster analysis, may vary in the amount of computation time required as well as the complexity of the computation because of the amount of data used as input, it may be advantageous to reduce the amount of data used to determine the one or more facies of the well. The complex process of analyzing a large amount of data obtained in 401 may be more efficiently done by reducing the complete dataset of the single well by identifying the minimum number of variables required to obtain similar segmentation of the data. For example, although a number of logs and/or known data may be available for use as input in 401, not all of the data may be beneficial when determining the one or more facies of a well. In addition, as data varies from well to well, one cannot rely on a single variable or the same set of variable to characterize and ultimately determine one or more facies of each well. On the other hand, the amount of data may be reduced from the complete dataset by properly selecting a reduced set of variables resulting in the same facies obtained as obtained during analysis of the complete dataset. Similarly, by identifying variables/data that do not significantly affect the segmentation of the dataset into one or more facies, the identified data may be discarded leaving only a reduced set of variables/data that maybe used in determining the segmentation (i.e., one or more facies) of a given formation.

Furthermore, numerical analysis techniques known in the art may also be used to reduce data. As mentioned above, in general, when one or more characteristics or variables (e.g., porosity and/or compression strength, among many others) of a given formation are analyzed and observed as having little to no effect on the segmentation or determination of the one or more facies of the given formation, these one or more characteristics and their corresponding data may be discarded. On the other hand, when one or more characteristics or variables (e.g., porosity and/or compression strength, among many others) of a given formation are analyzed and observed as having a significant effect on the segmentation or determination of the one or more facies of the given formation, these one or more characteristics and their corresponding data may be included. For example, plotting two or three dimensional plots of variables to determine a relationship between the variables and one or more facies may help in visually discriminating the variables that correlate to different segments. Additionally, plotting histograms and observing patterns in data that highlights their similarities and differences may help in identifying data that may be discarded or included. Those having ordinary skill would know and appreciate that many analysis techniques exist (e.g., primary component analysis) for correlating and reducing data that may be used to reduce the amount of data used in the segmentation process. After the minimum amount of data for segmentation has been identified by reducing data in 403, the segmentation of the formation may be used in conjunction with additional well data in order to determine the segmentation of a formation across multiple regions in 405.

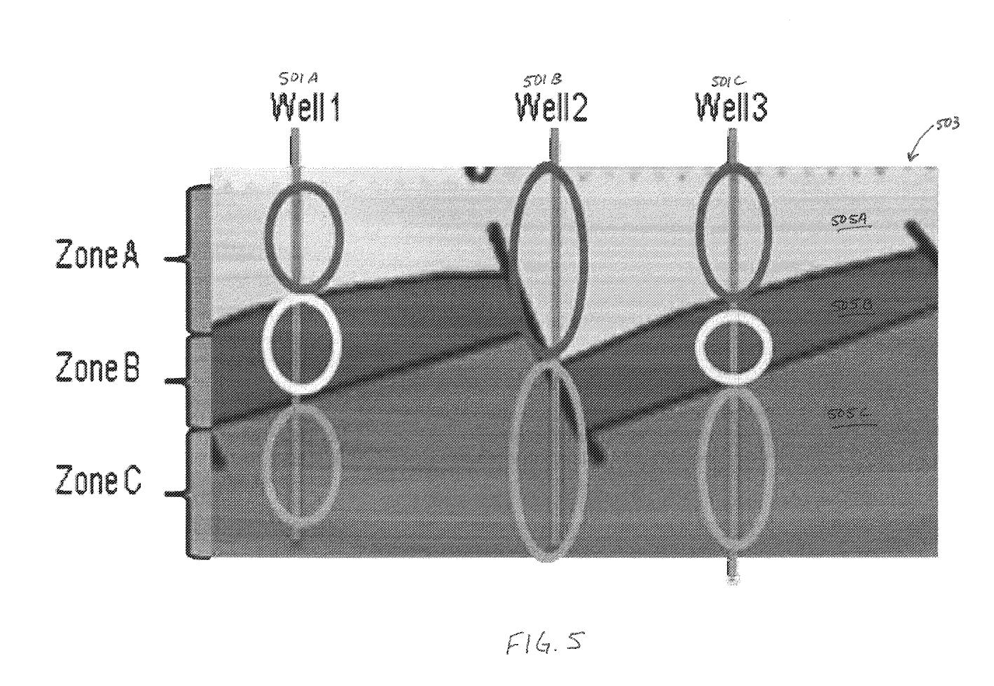

Referring to FIG. 5, a representation of multi-well zonation is shown. Here, zonation refers to the segmentation of data from multiple wells of an earth formation and the correlation of the segmented data from the multiple wells with one another in order to determine one or more drilling facies. In particular, as segmentation of single well data was done in 401 (and reduced in 403), the reduced set of data may aide in determining facies across multiple wells of a formation. As shown, multiple wells 501A, 501B, and 501C, penetrate earth formation 503. Earth formation 503 is shown having multiple layers or facies 505A, 505B, and 505C. Furthermore, each of the multiple wells 501A, 501B, 501C, penetrate a different portion of each of the multiple facies 505A, 505B, and 505C. For example, well 501A penetrates each of the multiple facies 505A, 505B, and 505C, while well 501B penetrates facies 505A and 505C. Therefore, when correlating well data obtained from wells 501A, 501B, and 501C with one another, a more accurate or refined segmentation of an earth formation may be obtained. In particular, one or more facies and their corresponding boundaries across a given earth formation may be more accurately determined using data from multiple wells (such as multiple wells 501A, 501B, and 501C) when compared to using only data from a single well.

Referring back to FIG. 4, after zonation is determined for multiple wells in 504, drilling performance of various drilling systems and operating parameters through each facie is analyzed in each facie using available data (e.g., from offset wells or other nearby wells) in 407. Drilling system performance such as ROP, mechanical specific energy, bit grading, and/or seismic and velocity signature, may be analyzed based on each facie (such as facies A, B, and C in FIG. 5). By analyzing the drilling performance, drillability properties such as rock abrasiveness, rock strength, and heterogeneity may be estimated. In addition, by analyzing drilling performance in each of the one or more facies, steerability properties such as dog leg severity may also be estimated. One of ordinary skill would know and appreciate that other properties may also be analyzed. These properties, and their corresponding drilling performances, may help engineers optimize operating parameters for a particular drilling system for each facie. For example, using the obtained properties (e.g., drillability and steerability properties), an engineer may determine optimal operating parameters, such as WOB or RPM, as well as particular drilling system components, such as the drill bit type, in order to satisfy a particular criteria (such as maximum life of bit, or highest ROP, for example).

When analyzing drilling performance in 407, it may be determined that two facies exhibit the same drillability after multi-well zonation and drilling performance analysis. Alternatively, it may be determined that a single facie exhibits different drillability. Accordingly, data may be refined in 409 to undergo the segmentation process again beginning at 401. For example, if too much data was discarded in 403, or if not enough data was discarded in 403, data may need to be refined (i.e., added or removed from the reduced set of data obtained in 403) in 409 in order to more accurately determine the number and boundaries of one or more facies of an earth formation. Once data is refined, the one or more facies of an earth formation may be accurately determined and may be used by an engineer to determine an optimal strategy for drilling through a particular formation. The optimal strategy may include optimized drilling system parameters as well as drilling operating parameters.

### Real Time Implementation

Analysis of drilling performance after a well has been drilled may help in determining the cause of bit failure, for example, and may help in the optimization of drilling system and operating parameters. However, in order to attempt to remedy and/or prevent failure, it may be helpful to implement analysis of drilling performance and drilling optimization strategy in real time during drilling.

Being able to discriminate facies having similar drillability and/or steerability properties within a formation, and effectively doing so prior to drilling through a particular earth formation may provide a means to optimize a particular drilling operation and efficiently and successful complete a drilling operation. Characterization and distinction of one or more drilling facies of an earth formation and correspondingly, determining the drillability and steerability properties of the earth formation may allow for more successful drilling operations. Accordingly, implementation of real time recognition and prediction of rock layers of an earth formation being drilled therethrough may be desirable.

In one or more embodiments, a trained Artificial Neural Network (ANN) may be used to determine optimum drilling system and operating parameters based on one or more drilling facies of a given earth formation. The ANN may be trained using data obtained from laboratory experimentation or from existing wells that have been drilled near the present well, such as an offset well.

ANNs are a relatively new data processing mechanism. ANNs emulate the neuron interconnection architecture of the human brain to mimic the process of human thought. By using empirical pattern recognition, ANNs have been applied in many areas to provide sophisticated data processing solutions to complex and dynamic problems (i.e., classification, diagnosis, decision making, prediction, voice recognition, military target identification, to name a few).

Similar to the human brain's problem solving process, ANNs use information gained from previous experience and apply that information to new problems and/or situations. The ANN uses a “training experience” (i.e., the data set) to build a system of neural interconnects and weighted links between an input layer (i.e., independent variable), a hidden layer of neural interconnects, and an output layer (i.e., the dependent variables or the results). No existing model or known algorithmic relationship between these variables is required, but such relationships may be used to train the ANN. An initial determination for the output variables in the training exercise is compared with the actual values in a training data set. Differences are back-propagated through the ANN to adjust the weighting of the various neural interconnects, until the differences are reduced to the user's error specification. Due largely to the flexibility of the learning algorithm, non-linear dependencies between the input and output layers, can be “learned” from experience. The term “real-time” is defined in the MCGRAW—HILL DICTIONARY OF SCIENTIFIC AND TECHNICAL TERMS (6th ed., 2003) on page 1758. “Real-time” pertains to a data-processing system that controls an ongoing process and delivers its outputs (or controls its inputs) not later than the time when these are needed for effective control. In this disclosure, “in real-time” means that optimized drilling parameters for an upcoming segment of formation to be drilled are determined and returned to a data store at a time not later than when the drill bit drills that segment. The information is available when it is needed. This enables a driller or automated drilling system to control the drilling process in accordance with the optimized parameters. Thus, “real-time” is not intended to require that the process is “instantaneous.”

The term “next segment” generally refers to a future portion of a formation ahead of the drill bit's current position that is to be drilled by the drill bit. A segment does not have a specified length. In one or more embodiments, the “next segment” comprises a change in formation lithology, porosity, compressive strength, shear strength, rock abrasiveness, the fluid in the pore spaces in the rock, or any other mechanical property of the rock and its contents that may require a change in drilling parameters to achieve an optimum situation. In addition, the next segment may also include a change in drilling facies, for example, when a drilling system encounters or will encounter a facie having different drillability and/or steerability than the current facie being drilled through. The next segment may extend to another change in formation lithology. In other embodiments, a segment may be broken into a selected size based on a size that is practical for use in optimizing drilling system and operation parameters.

The word “remote” is defined in THE CHAMBER'S DICTIONARY (9th ed., 2003) on page 1282. It is an adjective meaning “far removed in place, . . . widely separated.” In relation to computers, THE CHAMBER'S DICTIONARY defines “remote” as “located separately from the main processor but having a communication link with it.” In this disclosure, “remote” means at separate location (e.g., removed from the drilling site), but having a communication link (e.g., satellite, internet, etc.). For example, a “remote data store” may be at a different location from a drilling site. In one example, a “remote data store” is located at the location where the drilling system and operating parameters are optimized. In addition, a “remote data store” may be located at the drilling site, but remote from the drilling parameter optimization. In many embodiments, however, a “remote data store” is located remote from both the drilling site and the location where the drilling parameter optimization is performed.

The “current well” is the well for which drilling optimization is being performed. The current well is set apart from an offset well or other types of wells that may be drilled in the same area. “Current well data” refers to data that related to the current well. The data relating to the current well may have been taken at any time.

In this disclosure, “previously acquired data” refers to at least (1) any data related to a well drilled in the same general area as the current well, (2) any data related to a well drilled in a geologically similar area, or (3) seismic or other survey data. Previously acquired may be any data that may aid the predictive process described herein. Typically, previously acquired data is data obtained from the drilling of an “offset well” in the same area. Generally, an offset well has a smaller diameter than a typical production well. Offset wells are drilled to learn more information about the subterranean formations. In addition, data from previously or concurrently drilled other well bores in the same area may be used as previously acquired data. Further, previously acquired data may include data computed based one data obtained from one or more wells of a particular earth formation.

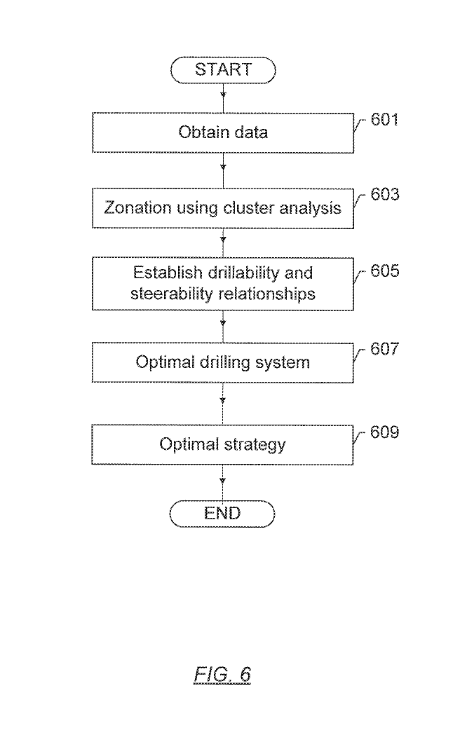

Referring now to FIG. 6, a method in accordance with one or more embodiments is shown. In one or more embodiments, one or more of the elements shown in FIG. 6 may be omitted, repeated, and/or substituted. Accordingly, embodiments of the present disclosure should not be considered limited to the arrangement of elements shown in FIG. 6.

In one or more embodiments, the method is performed by a drilling optimization service. One such service, called DBOS™, is offered by Smith International, Inc., the assignee of the entire right in the present application. A method for optimizing drilling system and operating parameters may be performed at a location that is remote from the drilling site. A remote data store may also be at any location. It is within the scope of the invention for a data store to be located at the drilling site or at the same location where the method for optimizing drilling system and operating parameters is being performed. In some embodiments, the data store is remote from at least one, if not both, of the drilling site and the location of the drilling parameter optimization.

As shown in FIG. 6, the method includes obtaining data at 601. In some embodiments, the data obtained may include previously acquired data and the previously acquired data may be known before the current well is drilled or being drilled. Thus, the data may be provided to a drilling optimization service before the current well is drilled. In other embodiments, the previously acquired data may be stored in the data store, and the previously acquired data may be queried from the data store—either separately or together with current well data.

In addition, obtaining data 601 may include obtaining the current well data. In some embodiments, this may include querying the data store to obtain all of the data that is available for the current well. In other embodiments, current well data may include only a certain portion of the data for the current well. The current well data may include any data related to the current well, the formations through which the current well passes and their contents, as well as data related to the drill bit and other drilling conditions. For example, current well data may include the type, design, and size of the drill bit that is being used to drill the well. Current well data may also include any rig sensed data and LWD/MWD data that has been obtained.

In one or more embodiments, an ANN, may be trained to optimize the drilling system and operating parameters using the obtained data in 601 as inputs. For example, training an ANN includes providing the ANN with a training data set. A training data set includes known input variables and known output variables that correspond to the input variables. The ANN then builds a series of neural interconnects and weighted links between the input variables and the output variables. Using this training experience, an ANN may then predict unknown output variables based on a set of input variables.

To train the ANN to determine drillability and steerability properties, a training data set may include known input variables (representing well data, e.g., previously acquired data) and known output variables (drillability and/or steerability properties corresponding to the well data). After training, an ANN may be used to determine unknown formation properties based on measured well data. For example, raw current well data may be input to a computer with a trained ANN. Then, using the trained ANN and the obtained well data, the computer may output estimations of the drillability and steerability properties.

In one or more embodiments, the method may next include zonation, as described above, where the obtained data may be segmented in one or more facies using cluster analysis. Based on the correlation of the current well data to the previously acquired data, a prediction may be made about the facie to be drilled—that is, the formation in front of the drill bit. In some cases, this may include a prediction that the characteristics of the formation to be drilled are not changing. In other cases, the prediction may include a change in formation or rock characteristics for the next segment. In addition, once data is obtained in 601 and analyzed in 603, relationships between drillability and steerability may be established in 605. As the the facie to be drilled predicted using a trained ANN. In such embodiments, the ANN may be trained using a training data set that includes the previously acquired data and the correlation of well data to offset well data as the inputs and known next segment formation properties as the outputs. Using the training data set, the ANN may build a series of neural interconnects and weighted links between the input variables and the output variables. Using this training experience, an ANN may then predict unknown formation properties for the next segment based on inputs of previously acquired data and the correlation of the current well data to the previously acquired data.

Possible changes in formation or rock characteristics include changes in the rock compressive strength or shear strength, or changes on other rock mechanical properties. These changes may result from crossing a facie boundary. For example, a drill bit that is currently drilling through one facie may be predicted to cross a facie boundary in the next segment so that the drill bit will then be drilling a facie having different drillability or steerability properties. Thus, when the drill bit crosses the facie boundary, the new facie will generally have different properties requiring different drilling system and operating parameters to be used for an optimal condition.

One of the main challenges of NN is the large amount of prior data needed to properly train the NN. When zonation is done, various NN can be trained by facie (or zone). Detection of a current facie may be done by any other process. Thereafter, properly trained NN for that facie may be accessed and later applied during a particular drilling operation. Tools providing look ahead measurement (i.e., measurements taken to determine upcoming drilling conditions) may be used to detect facie transition in time. Alternatively, another option is to detect changes through analysis of vibration signature, ROP, and/or drilling system or operating parameters and/or their relationship with respect to torque and weight on bit.

One such technique is known as an ES plan. Using an ES plan, specific energy (E) and drilling strength (S), each having units of stress (Force per unit area), may be calculated using one or more of WOB, torque, RPM, and/or ROP. During operation, and in particular, during a real-time operation, specific energy (E) and drilling strength (S) may be calculated in order to determine a change in facie. As the calculation of specific energy (E) and drilling strength (S) may depend on one or more operating parameters, as mentioned above, an ES plan may be used to quickly detect or determine when a drill bit crosses different layers or penetrates a different facie (i.e., a facie transition) without the use of one or more measurements acquired from other downhole tools (such as a measurement from a LWD/MWD tool, for example).

Next, the method may include optimizing drilling system parameters and drilling operating parameters at 607 based on drillability and steerability properties obtained in 605. The optimum drilling parameters are determined for drilling the next segment, based on the drill bit being used and the predicted drillability and steerability properties of the next segment. Once determined, the optimum drilling parameters may be uploaded to the data store so that they are available to rig personnel and other parties needing the information. In some embodiments, an automated drilling control system queries the data store for the optimum drilling parameters and controls the drilling process accordingly.

The optimized parameters are recommended drilling system and operating parameters for drilling the next segment. Such parameters may include WOB, TOB, RPM, mud flow rate, mud density, and any other drilling parameter that is controlled by a driller. In some embodiments, the drilling parameters are optimized for the current drill bit. In other embodiments, the optimized parameters may include a recommendation to change the drill bit for the next segment. A drastic change in drillability may require a different type of drill bit for the best optimization of the drilling parameters.

Determining the optimized parameters may be based on one or more criteria. For example, in one embodiment, the drilling parameters are optimized to drill the well in the most economical way. This may include balancing the life of the bit with maximizing the ROP. In one particular embodiment, this includes determining an ellipse representing acceptable values for bit life and ROP, and the drilling parameters are selected so that the bit life and ROP fall in the ellipse.

Other examples of criteria that may be used for optimizing drilling system and operating parameters include reducing vibration, as well as directional plan and target considerations. Vibration may be very harmful to a drill bit. In extreme cases, vibration may cause premature catastrophic failure of the drill bit. If vibration is detected or predicted, the drilling system and operating parameters may be optimized to reduce the vibration, even though the vibration-optimized parameters may not produce the most economically drilled well or segment. Also, if the directional plan calls for a specified build angle to reach a particular underground target, such a priority may take precedence over economic or ROP considerations. In such a case, the drilling parameters may be optimized to maintain the desired well trajectory.

In some embodiments, optimizing drilling system and operation parameters includes predicting the wear and/or wear rate of the drill bit (i.e., drill bit dulling). The amount of drill bit dulling that has already occurred will affect the way the drill bit drills the next segment, and the amount of dulling may have an effect on the optimized parameters. The amount of drill bit dulling that has occurred may be estimated based on current well data for those portions of the formation that have already been drilled, as well as data related to such things as WOB, TOB, RPM, mud flowrate, drilling pressure, and data related to measurements of the drill bit properties while drilling. In addition, the optimization may include predicting the level of drill bit dulling that will occur while drilling the next segment. In addition, after tripping the drill string, the amount of dulling may be specified or reset following an inspection or replacement of the drill bit.

In addition to predicting the dulling that has occurred, an optimization method may include predicting the hours of bit life remaining. This may be accomplished by predicting how the drill bit will wear while drilling the next segment, and other future segments, using the optimized drilling parameters. This may also enable the determination of the depth at which the drill bit will wear out or fail, if that may occur before the drill bit reached the target or planned depth.

It may be possible that the real time measurements reveal that the planned target may not be in the location where it was thought to be. In such a case, the target may be revised during the drilling process. In such a case, the optimization method may devise a new optimal strategy in 609 and account for the new direction plan in the drilling priorities. In other cases, a new directional plan may be uploaded to the data store for use in the optimization method. In some embodiments, a method for optimizing drilling system and operating parameters include predicting optimized parameters for the entire run of the drill bit to the planned depth. The method may include consideration of predicted drillability and/or steerability properties for the entire run based on correlations of the current well data to previously acquired data and propose an optimal strategy in 609.

As discussed above, optimizing the drilling system and operating parameters as well as an optimal strategy, if necessary, may include the use of a trained ANN. In such embodiments, the ANN may be trained using a training data set that includes the known formation properties, drill bit properties, and drilling priorities as the inputs and known optimum parameters as the training outputs. As was mentioned above, a computer having a trained ANN installed thereon may be used to perform the correlation to previously acquired data, prediction of next segment properties, and drilling system and operating optimization. These may be performed by a computer, using one or more ANNs to determine the optimized drilling system and operating parameters. The current well data and the previously acquired data may be input into the computer or ANN, and the outputs would be the optimized drilling parameters for the next segment.

The method may include using an automated drilling system to control the drilling process. In that case, the automated drilling system may query the data store for the optimized drilling system and operating parameters and control the drilling accordingly. A typical automated drilling system uses servos and other actuators to operate conventional drilling control. It is usually done this way so that a driller may take over the process by disengaging the automated system and operating the control in the conventional way. However, other automated systems, for example computer control of the entire process, may be used without departing from the scope of the present invention.

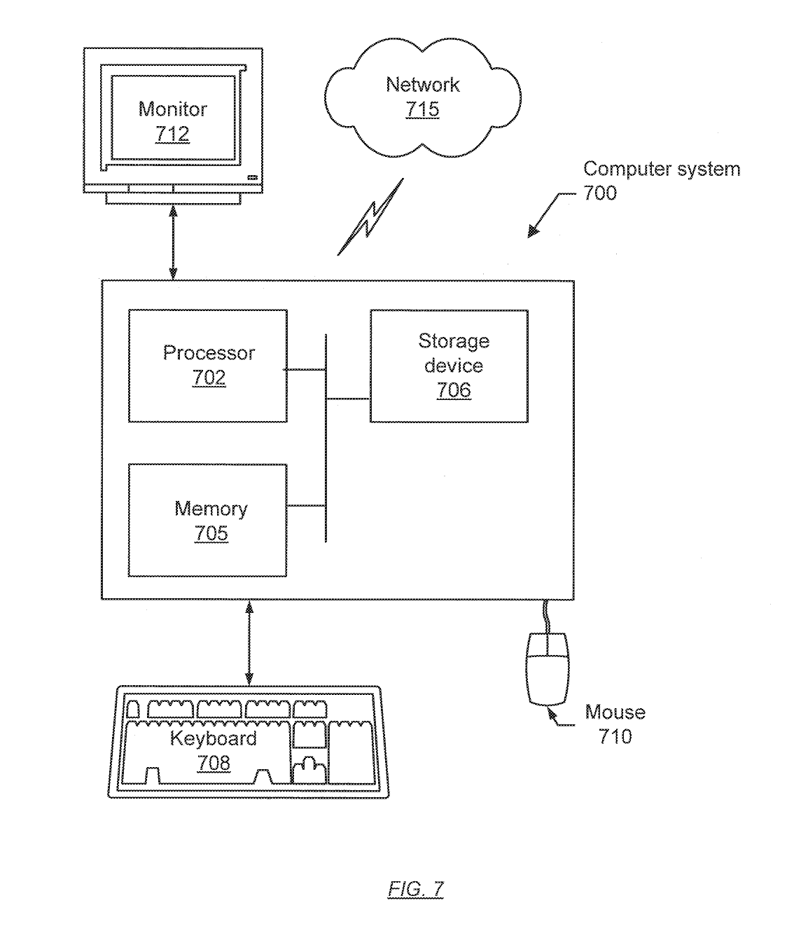

Embodiments of the present disclosure may be implemented on virtually any type of computer regardless of the platform being used. For instance, as shown in FIG. 7, a computer system (700) includes one or more processor(s) (702) such as a central processing unit (CPU) or other hardware processor, associated memory (705) (e.g., random access memory (RAM), cache memory, flash memory, etc.), a storage device (706) (e.g., a hard disk, an optical drive such as a compact disk drive or digital video disk (DVD) drive, a flash memory stick, etc.), and numerous other elements and functionalities typical of today's computers (not shown). The computer (700) may also include input means, such as a keyboard (708), a mouse (710), or a microphone (not shown). Further, the computer (700) may include output means, such as a monitor (712) (e.g., a liquid crystal display LCD, a plasma display, or cathode ray tube (CRT) monitor). The computer system (700) may be connected to a network (715) (e.g., a local area network (LAN), a wide area network (WAN) such as the Internet, or any other similar type of network) via a network interface connection (not shown). Those skilled in the art will appreciate that many different types of computer systems exist (e.g., workstation, desktop computer, a laptop computer, a personal media device, a mobile device, such as a cell phone or personal digital assistant, or any other computing system capable of executing computer readable instructions), and the aforementioned input and output means may take other forms, now known or later developed. Generally speaking, the computer system (700) includes at least the minimal processing, input, and/or output means necessary to practice one or more embodiments.

Further, those skilled in the art will appreciate that one or more elements of the aforementioned computer system (700) may be located at a remote location and connected to the other elements over a network. Further, one or more embodiments may be implemented on a distributed system having a plurality of nodes, where each portion of the implementation may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform one or more embodiments may be stored on a computer readable medium such as a compact disc (CD), a diskette, a tape, or any other computer readable storage device.

Using one or more embodiments described above, obtained results may be used to select or determine an optimal strategy of bit runs, drilling systems and components, as well as optimal operating parameters that meet a given criteria such as, for example, cost per foot, reduced level of vibration, and/or risk of tool/bit failure. Furthermore, establishing a relationship between drilling performance based on segments of a formation may also provide drilling engineers with additional information that may be used to select specific components of a drilling system for a given application or situation as well as determine optimal operating parameters that may be helpful for the success of a particular field operation.

In addition, although described above with respect to drillability, a relationship between drilling performance and facie may also aide in determining the steerability through a particular formation when drilling horizontal or direction wells. For example, dog leg severity may be analyzed for a given drilling system and operating parameters in order to determine optimal strategy for steering a drilling system through the formation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. Moreover, embodiments described herein may be practiced in the absence of any element that is not specifically disclosed herein.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A method for selecting a drill bit, the method comprising:
obtaining a plurality of data of a first well within an earth formation;
correlating the plurality of data of the first well to identify a set of reduced variables of the plurality of data;
segmenting the reduced set of the plurality of data into a plurality of facies based on one of drillability and steerability;
performing analysis of drilling performance of each of the plurality of facies; and
selecting a drill bit based on the drilling performance.

2. The method of claim 1, wherein the reduced set of variables is identified using a cluster analysis technique.

3. The method of claim 1, further comprising:
correlating the plurality of facies with one or more additional wells within the earth formation;
performing analysis of drilling performance of each of the plurality of facies based on the one or more additional wells; and
selecting a drill bit based on the results of the performed analysis.

4. The method of claim 1, further comprising:
refining the set of reduced variables based on the performed analysis;
performing refined analysis of drilling performance of the refined set of reduced variables of each of the plurality of facies; and
selecting a drill bit based on the refined analysis.

5. The method of claim 1, further comprising:
refining the set of reduced variables based on the performed analysis;
performing refined analysis of drilling performance of the refined set of reduced variables of each of the plurality of facies; and
optimizing a drill bit based on the refined analysis.

6. The method of claim 1, further comprising:
refining the set of reduced variables based on the performed analysis;
performing refined analysis of drilling performance of the refined set of reduced variables of each of the plurality of facies; and
optimizing a drilling strategy based on the refined analysis.

7. The method of claim 1, wherein the drillability of one of the plurality of facies is similar to another one of the plurality of facies if the drilling performance is similar under similar conditions, wherein the conditions include drilling system parameters and operating parameters.

8. The method of claim 1, wherein the drilling performance includes at least one of rate of penetration, rotary torque, rotary speed, drilling tool assembly lateral, axial, or torsional vibrations and accelerations, bit wear, vibration signature, and weight on bit (WOB).

9. The method of claim 1, wherein the earth formation is a heterogeneous formation.

10. A method for real time optimization of an operating parameter during drilling, the method comprising:
measuring and obtaining a plurality of data of an earth formation in real time;
segmenting the earth formation into a plurality of facies by identifying one or more variables of the plurality of data using a cluster analysis technique; and
predicting a formation change based on the measured plurality of data.

11. The method of claim 10, wherein predicting the formation change comprises anticipating a parameter change based on a change in vibration signature or a change in mechanical specific energy.

12. The method of claim 10, wherein measuring comprises obtaining the plurality of data using at least one of a logging-while drilling technique, a seismic while drilling technique, a wireline technique, and a surface measurement technique.

13. The method of claim 10 further comprising:
optimizing drilling performance by changing an operating parameter based on the formation change.

14. The method of claim 10, wherein the operating parameter is at least one of speed at which the drilling tool assembly is rotated (RPM), the downhole motor speed, hook load, and rotary torque.

15. A method of optimizing drilling parameters, the method comprising:
obtaining previously acquired data of a well of the formation;
obtaining current data of the well of the formation;
estimating the property of the formation by comparing the current data to the previously acquired data; and
changing at least one of a drilling system parameter and a drilling operating parameter based on the estimated property.

16. The method of claim 15, wherein estimating the property of the formation further comprises:
obtaining next segment data of the current data of the well;
comparing the next segment data and the current data of the well to the previously acquired data of the well;
determining one or more facies of the formation; and
estimating the property of the formation based on the one or more facies.

17. The method of claim 15, wherein the estimating the property of the formation further comprises estimating at least one of a drillability property and steerability property.

18. The method of claim 16, wherein determining the one or more facies of the formation further comprises:
segmenting, using cluster analysis, the formation into one or more facies based on the previously acquired data and the current data of the well.

19. The method of claim 18, wherein segmenting further comprises:
correlating data obtained from one or more surrounding wells with the previously acquired data and the current data of the well.

20. The method of claim 15, wherein an artificial neural network (ANN) is used to compare the current data to the previously acquired data.

21. The method of claim 20, wherein the ANN estimates the property of the formation based on the comparison of the current data to the previously acquired data.

22. The method of claim 16, wherein determining one or more facies of the formation comprises:
calculating at least one of specific energy and drilling strength; and
determining at least one of a change in facie and a facie transition based on at least one of the calculated specific energy and the calculated drilling strength.
